(19) United States
(12) Patent Application Publication
(10) Pub. No.: US 2022/0340476 A1
(43) Pub. Date: Oct. 27, 2022

(54) THERMAL HISTORY-INSENSITIVE ALKALI-FREE GLASSES

(71) Applicant: Corning Incorporated, Corning, NY (US)

(72) Inventors: Timothy Michael Gross, Painted Post, NY (US); Alexandra Lai Ching Kao Andrews Mitchell, Ithaca, NY (US)

(21) Appl. No.: 17/620,809

(22) PCT Filed: Jun. 10, 2020
(86) PCT No.: PCT/US2020/036904

§ 371 Date: Dec. 20, 2021

Related U.S. Application Data
(60) Provisional application No. 62/866,962, filed on Jun. 26, 2019.

(51) Int. Cl. C03C 3/078

(52) U.S. Cl. CPC C03C 3/078

(57) ABSTRACT

An alkali-free glass including greater than or equal to 65.0 mol % SiO₂, mol % RO/mol % Al₂O₃ less than 0.7 (where RO can include divalent oxides MgO, CaO, SrO, BaO, or combinations thereof), RO less than or equal to 14 mol %, and the absolute value of a slope dE/dT_{f} of a line extending between a first endpoint and a second endpoint less than or equal to 10.0221 GPa/° C. The first endpoint is a Young's modulus at a fictive temperature of the annealing point temperature and the second endpoint is a Young's modulus at a fictive temperature of the strain point temperature, and the slope is a change in Young's modulus (GPa) per 1° C. change in fictive temperature. RO is a total amount of alkali earth metal oxides. A glass article is also disclosed.

### CROSS-REFERENCE TO RELATED APPLICATIONS

This application claims the benefit of priority of U.S. Provisional Application Ser. No. 62/866,962 filed on Jun. 26, 2019 the contents of which are relied upon and incorporated herein by reference in their entirety as if fully set forth below

### BACKGROUND

### Field

The present specification generally relates to glass compositions suitable for use in electronic display devices. More specifically, the specification is directed to alkali-free glasses that are thermal history-insensitive and that may be formed into glass substrates for electronic devices, for example as display substrates.

### Technical Background

Portable electronic devices, such as smartphones, tablets, and wearable devices (watches and fitness trackers for example) continue to get smaller and more complex. As such, requirements for glasses used to form substrates for the manufacture of display panels are becoming more stringent. For instance, as portable electronic devices get smaller and thinner to meet consumer demand, the glass substrates used in these portable electronic devices also become smaller and thinner, which results in lower tolerance for dimensional variations of the glass substrates. Similarly, tolerances for variations in glass substrates properties, e.g., strength, density, and elasticity, also diminish. Unfortunately, the dimensions and properties of glasses used as display substrates can change as the glass is cooled and during subsequent thermal processing, which can lead to glasses that meet specifications for portable electronic devices before cooling or finishing, but that do not meet the specifications for portable electronic devises after cooling or subsequent processing.

Accordingly, a need exists for glasses that maintain their dimensions and properties regardless of the thermal history of the glass.

### SUMMARY

According to a first embodiment, an alkali-free glass is disclosed, comprising equal to or greater than about 65.0 mol % SiO₂, less than or equal to about 14.0 mol % RO, where RO comprises at least one of MgO, CaO, SrO, or BaO, RO/Al₂O₃ is equal to or less than about 0.70, and an absolute value of a slope dE/dT_{f} of a line extending between a first endpoint and a second endpoint is less than or equal to 10.0221 GPa/° C., wherein the first endpoint is a Young's modulus of the alkali-free glass at a fictive temperature of an annealing point temperature of the alkali-free glass and the second endpoint is a Young's modulus of the alkali-free glass at a fictive temperature of a strain point temperature of the alkali-free glass.

The alkali-free glass may further comprise equal to or less than about 5.0 mol % B₂O₃.

In some embodiments, RO+B₂O₃ is equal to or less than about 15.0 mol %.

In various embodiments, dE/dT_{f} of the alkali-free glass can be equal to or less than about |0.017| GPa/° C.

In some embodiments, RO can comprise at least one of SrO, CaO or BaO.

In some embodiments, RO can be in a range from about 9.0 mol % to about 12.0 mol %.

In some embodiments, SiO₂ can be equal to or greater than about 70.0 mol %.

In other embodiments, an alkali-free glass is described, comprising equal to or greater than about 65.0 mol % SiO₂, equal to or less than about 5.0 mol % B₂O₃, less than or equal to about 14.0 mol % RO, where RO comprises at least one of MgO, CaO, SrO, BaO, or ZnO. The ratio RO/Al₂O₃ can be is equal to or less than about 0.70. the sum of RO+B₂O₃ can be equal to or less than about 15 mol %. In various embodiments, an absolute value of a slope dE/dT_{f} of a line extending between a first endpoint and a second endpoint is less than or equal to |0.022| GPa/° C., wherein the first endpoint is a Young's modulus of the alkali-free glass at a fictive temperature of an annealing point temperature of the alkali-free glass and the second endpoint is a Young's modulus of the alkali-free glass at a fictive temperature of a strain point temperature of the alkali-free glass.

In some embodiments of the alkali-free glass, SiO₂ can be equal to or greater than about 70.0 mol %.

In some embodiments, RO can comprise at least one of SrO or BaO.

In some embodiments, the absolute value of the slope dE/dT_{f} can be less than or equal to 10.0201 GPa/° C.

The alkali-free glass according to claim 8, wherein the absolute value of the slope dE/dT_{f} can be less than or equal to |0.017| GPa/° C.

The alkali-free glass can comprise Al₂O₃ in an amount from about 15.0 mol % to about 18.0 mol %.

In some embodiments, the alkali-free glass can comprise B₂O₃ in an amount equal to or less than about 5.0 mol %.

In still other embodiments, a glass article is disclosed, comprising a first glass substrate, the first glass substrate comprising an electrically-functional element deposited thereon, the first glass substrate further including an alkali-free glass comprising equal to or greater than about 65.0 mol % SiO₂, less than or equal to about 14.0 mol % RO, where RO comprises at least one of MgO, CaO, SrO, BaO, or ZnO, RO/Al₂O₃ equal to or less than about 0.70, and an absolute value of a slope dE/dT_{f} of a line extending between a first endpoint and a second endpoint is less than or equal to 10.022| GPa/° C., wherein the first endpoint is a Young's modulus of the alkali-free glass at a fictive temperature of an annealing point temperature of the alkali-free glass and the second endpoint is a Young's modulus of the alkali-free glass at a fictive temperature of a strain point temperature of the alkali-free glass.

In some embodiments, the electrically-functional element can comprise an electroluminescent element. The electroluminescent element can, for example, comprise a light emitting diode, such as an organic light emitting diode.

In other embodiments, the electrically-functional element can comprise a photo-electric element.

The alkali-free glass may further comprise equal to or less than about 5.0 mol % B₂O₃.

In some embodiments, RO+B₂O₃ can be equal to or less than about 15 mol %.

In some embodiments, RO can comprise at least one of Sr, Ca or BaO.

In some embodiments, SiO₂ can be equal to or greater than about 70.0 mol %.

Additional features and advantages will be set forth in the detailed description which follows, and in part will be apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments and are incorporated into and constitute a part of this specification. The drawings illustrate the various embodiments described herein and, together with the description, explain the principles and operations of the claimed subject matter.

### BRIEF DESCRIPTION OF THE DRAWINGS

FIG. 1 is a plot showing Young's modulus in gigaPascals (GPa) as a function of fictive temperature for glasses having varying amounts of silica;

FIG. 2 is a plot illustrating Young's modulus in gigaPascals as a function of fictive temperature for glasses comprising three different divalent oxides, CaO, SrO and BaO, and further indicating the slope of the change in Young's modulus for each;

FIG. 3 is a plot of Young's modulus as a function of fictive temperature at anneal and strain points for three glasses comprising, respectively, CaO, SrO and BaO, and where the amount of RO is greater than the amount of Al₂O₃;

FIG. 4 is a plot of Young's modulus as a function of fictive temperature at anneal and strain points for three glass comprising, respectively, CaO, SrO and BaO, and where the amount of RO is less than the amount of Al₂O₃;

FIG. 5 is a cross-sectional side view of an exemplary electronic (display) device comprising an alkali-free glass in accordance with the present disclosure; and

FIG. 6 is a plot comparing slopes of Young's modulus for three glasses, soda lime glass (SLS), Eagle XG glass, and an alkali-free glass (Example 1) according to the present disclosure.

### DETAILED DESCRIPTION

Reference will now be made in detail to embodiments of the present disclosure, examples of which are illustrated in the accompanying drawings. Whenever possible, the same reference numerals will be used throughout the drawings to refer to the same or like parts. However, this disclosure may be embodied in many different forms and should not be construed as limited to the embodiments set forth herein.

Ranges can be expressed herein as from “about” one particular value, and/or to “about” another particular value. When such a range is expressed, another embodiment includes from the one particular value to the other particular value. Similarly, when values are expressed as approximations by use of the antecedent “about,” it will be understood that the particular value forms another embodiment. It will be further understood that the endpoints of each of the ranges are significant both in relation to the other endpoint, and independently of the other endpoint, and ranges as expressed include endpoints unless otherwise indicated.

As used herein, the singular forms “a,” “an” and “the” include plural references unless the context clearly dictates otherwise. Thus, for example, reference to “a” component includes aspects having two or more such components, unless the context clearly indicates otherwise.

The word “exemplary,” “example,” or various forms thereof are used herein to mean serving as an example, instance, or illustration. Any aspect or design described herein as “exemplary” or as an “example” should not be construed as preferred or advantageous over other aspects or designs. Furthermore, examples are provided solely for purposes of clarity and understanding and are not meant to limit or restrict the disclosed subject matter or relevant portions of this disclosure in any manner. It can be appreciated that a myriad of additional or alternate examples of varying scope could have been presented but have been omitted for purposes of brevity.

As used herein, the terms “comprising” and “including”, and variations thereof, shall be construed as synonymous and open-ended, unless otherwise indicated.

Non-alkali-containing aluminosilicate glasses with good physical properties and chemical durability have drawn attention for use as electronic substrate glasses for displays. However, various properties of glasses can change depending on the manufacturing method used to produce the glass. For instance, properties of glass made in small amounts during research and development can be significantly different than the properties of the same glass made at a production scale. Likewise, manufacturing methods used at production scale can vary widely, which can cause the properties of glasses with similar compositions to vary depending on the manufacturing method used to manufacture the glass. Without being bound by theory, it is believed the cooling rate a glass experiences—which can affect the final properties and structure of a glass—can change based on the manufacturing method, from crucible melts to research-scale melters to production-scale tanks. Therefore, significant effort may be required to reproduce the thermal history glasses undergo during small-scale production to theoretically determine the properties of production-scale glasses.

Not only are glass structures and properties susceptible to change as a function of cooling rates, but they can also be affected by high temperature post-processing steps, such as thin film transistor deposition on glass substrates. Compaction (shrinkage) of glasses that undergo high temperature processes can affect the outcome of post-thermal processing steps. In the case of glasses used as glass substrates for display applications, the electronic circuit pattern and the glass substrate can become mismatched, and it may be necessary to make process adjustments and corrections, which can be difficult, time consuming, and may not completely solve the problem. Accordingly, whether it is to maintain properties during initial glass formation or to eliminate changes in properties during post-processing steps, there is a demonstrated need for glasses with thermal history-insensitive structure and properties. The thermal history-insensitive alkali-free glasses disclosed herein can provide such stable structure and properties. As used herein, alkali-free refers to a glass comprising equal to or less than about 0.07 mol % total alkali metals, e.g., lithium (Li), sodium (Na), potassium (K), rubidium (Rb), cesium (Cs), and francium (Fr).

Physical properties of such alkali-free glasses will now be discussed. These physical properties can be achieved by modifying the constituent amounts of the glass composition, as will be discussed in more detail with reference to the examples.

Fictive temperature T_{f} is a parameter effective for characterizing the structure and properties of a glass. The cooling rate from the melt affects the fictive temperature. For ‘normal’ glasses, the faster the cooling rate, the higher the fictive temperature. The opposite trend is observed for anomalous glasses, although only normal glasses are disclosed here. For glasses characterized as ‘normal’, properties such as Young's modulus, shear modulus, refractive index, and density decrease with increasing fictive temperature. The rate of change in these properties with fictive temperature depends on glass composition. The fictive temperature of the glass can be set by holding the glass at a given temperature in the glass transition range. The minimum time required to reset the fictive temperature can be approximated by 30×((the viscosity of the glass at the heat treatment temperature)/shear modulus). To ensure full relaxation to the new fictive temperature, glasses may be held at times far exceeding 30×((the viscosity of the glass at the heat treatment temperature)/shear modulus).

As fictive temperature decreases, certain glasses (soda-lime silicates for example) exhibit increasing density, hardness, elastic modulus, and refractive index. For these glasses, the structure of the glass resembles the open structure of the melt upon fast cooling (high fictive temperature), but the glass compacts to a denser structure closer to a solid upon slow cooling (low fictive temperature). Other glasses (glasses of SiO₂ for example) exhibit the opposite property trends: decreasing density, hardness, elastic modulus, and refractive index as a function of decreasing fictive temperature. The opposing trends exhibited by these different glasses can be used to define glass compositions with properties that are insensitive to thermal history (also referred to herein as “fictive temperature-independent”).

Fictive temperature-independent glasses can be melted using conventional techniques and have properties that do not change (or change very little) as a function of thermal history. Glasses with thermally stable properties are valuable for products that require high temperature post-processing, as the glass will not shrink when exposed to high temperature.

The sensitivity of a glass to its thermal history may be measured by comparing the Young's modulus of the glass with the fictive temperature set to the annealing point temperature (referred to herein as the “first endpoint”) and the Young's modulus of the glass with the fictive temperature set to the strain point temperature (referred to herein as the “second endpoint”). Glasses with low sensitivity to their thermal history will have a Young's modulus at the first endpoint similar to the Young's modulus at the second endpoint, because this shows Young's modulus is not significantly affected by the thermal history of the glass. Thus, the sensitivity of the glass composition to its thermal history may be determined by the slope of a line between the first endpoint and the second endpoint. In such embodiments, the slope is defined as the change in Young's modulus E (gigaPascals, GPa) per 1° C. change in fictive temperature. Particularly, the closer the slope dE/dT_{f} of such a line gets to 0.0, the less sensitive the glass is to its thermal history. The value of the slope can be expressed as an absolute value. It does not matter whether the slope of a line extending between the first endpoint and the second endpoint is positive or negative. For example, when the Young's modulus of a glass is measured at the first endpoint and the second endpoint, and the slope of a line extending between the first endpoint and the second endpoint is 0.02, the sensitivity of the glass to its thermal history will be about the same as the sensitivity of a glass where the slope dE/dT_{f} of a line extending between the first endpoint and the second endpoint is −0.02. Thus, the slope of dE/dT_{f} of Young's modulus as a function of fictive temperature may be expressed as an absolute value and designated with bracketing vertical bars, e.g., |0.02|. For example, where a slope dE/dT_{f} is indicated as “equal to or less than |0.020|” the expression refers to the absolute value of the slope, such that a slope in the range from −0.020 to 0.020 is included. Where bracketing vertical bars are not present, the value provided is not the absolute value.

Young's modulus is used as the first endpoint and the second endpoint to determine the sensitivity of a glass to its thermal history because Young's modulus can be measured with good accuracy, such as by using the method described below. In embodiments, the absolute value of the slope of a line extending between the first endpoint and the second endpoint is equal to or less than |0.022| GPa/° C., such as equal to or less than |0.019| GPa/° C., equal to or less than |0.018| GPa/° C., equal to or less than |0.017| GPa/° C., equal to or less than |0.016| GPa/° C., equal to or less than |0.015| GPa/° C., equal to or less than |0.014| GPa/° C., equal to or less than |0.013| GPa/° C., equal to or less than |0.012| GPa/° C., equal to or less than |0.011| GPa/° C., equal to or less than |0.010| GPa/° C., equal to or less than |0.009| GPa/° C., equal to or less than |0.008| GPa/° C., equal to or less than |0.007| GPa/° C., equal to or less than |0.006| GPa/° C., equal to or less than |0.005| GPa/° C., equal to or less than |0.004| GPa/° C., equal to or less than |0.003| GPa/° C., equal to or less than |0.002| GPa/° C., or equal to or less than |0.001| GPa/° C. In some embodiments, dE/dT_{f} can be in a range from about 10.005|GPa/° C. to about 10.022| GPa/° C., for example in a range from about 10.008| GPa/° C. to about 10.022| GPa/° C., such as in a range from about 10.008| GPa/° C. to about 10.017| GPa/° C., or in a range from about 10.008| GPa/° C. to about 10.015| GPa/° C. For each of the above values, the absolute value of the slope of a line extending between the first endpoint and the second endpoint is equal to or greater than 10.0001.

Without being bound by any particular theory, it is believed that glasses where an absolute value of the slope of a line extending between the first endpoint and the second endpoint is equal to or less than |0.022| GPa/° C. are particularly useful because the volume of such glasses do not change, or change very little, regardless of the manufacturing method and conditions used to manufacture the glass. It is believed, again without being bound by any particular theory, that glasses comprising high amounts of silica, and possibly other tetrahedral units, are likely to be insensitive to their thermal histories and may be more likely to have an absolute value of a slope of a line extending between the first endpoint and the second endpoint that is equal to or less than |0.022| GPa/° C.

Additionally, it was found that for alkali-free glasses containing alumina and one or more divalent oxides (e.g., MgO, CaO, SrO, and/or BaO), represented herein as RO, when the amount of Al₂O₃ exceeds the amount of RO a reduction in dE/dT_{f} can be obtained. Indeed, it was found that the presence of low field strength divalent oxides also correlated with reducing the slope of Young's modulus, and further that low field strength divalent oxides can provide lower Young's modulus slopes than high field strength divalent oxides. Glass compositions that meet these requirements are described below.

Alkali-free glasses according to various embodiments may have a density, regardless of fictive temperature, in a range from about 2.40 g/cm³ to about 2.80 g/cm³, such as in a range from about 2.25 g/cm³ to about 2.80 g/cm³, in a range from about 2.50 g/cm³ to about 2.80 g/cm³, including all ranges and sub-ranges between the foregoing values. The density values recited in this disclosure refer to a value as measured by the buoyancy method of ASTM C693-93(2013).

Alkali-free glasses according to embodiments may have a Young's modulus, regardless of fictive temperature, in a range from about 74.0 GPa to about 92.0 GPa, such as in a range from about 75.0 GPa to about 91.0 GPa, in a range from about 76.0 GPa to about 90.0 GPa, including all ranges and sub-ranges between the foregoing values. The Young's modulus values recited in this disclosure refer to a value measured by a resonant ultrasonic spectroscopy technique of the general type set forth in ASTM E2001-13, titled “Standard Guide for Resonant Ultrasound Spectroscopy for Defect Detection in Both Metallic and Non-metallic Parts.”

According to one or more embodiments, the alkali-free glasses disclosed herein may have a Poisson's ratio, regardless of fictive temperature, in a range from about 0.215 to equal to or less than about 0.233, such as in a range from about 0.217 to about 0.231, in a range from about 0.219 to about 0.230, or in a range from about 0.220 to about 0.229, including endpoints of the ranges, and all ranges and sub-ranges between the foregoing values. The Poisson's ratio values recited in this disclosure refer to a value as measured by a resonant ultrasonic spectroscopy technique of the general type set forth in ASTM E2001-13, titled “Standard Guide for Resonant Ultrasound Spectroscopy for Defect Detection in Both Metallic and Non-metallic Parts.”

The alkali-free glass may, in one or more embodiments, have a strain temperature (strain point), regardless of fictive temperature, in a range from about 718° C. to equal to about 837° C., such as in a range from about 720° C. to about 825° C., in a range from about 740° C. to about 810° C., including all ranges and sub-ranges between the foregoing values. The strain point was determined using the beam bending viscosity method of ASTM C598-93(2013).

In embodiments, the alkali-free glass can have an annealing temperature (annealing point), regardless of fictive temperature, in a range from about 765° C. to about 894° C., such as in a range from about 775° C. to about 880° C., in a range from about 780° C. to about 875° C., or in a range from about 785° C. to about 860° C., including all ranges and sub-ranges between the foregoing values. The annealing point was determined using the beam bending viscosity method of ASTM C598-93(2013).

The alkali-free glass may, according to embodiments, have a softening temperature (softening point), regardless of fictive temperature, in a range from about 1015° C. to about 1155° C., such as in a range from about 1015° C. to about 1151° C., in a range from about 1015° C. to about 1136° C., or in a range from about 1015° C. to about 1130° C., including all ranges and sub-ranges between the foregoing values. The softening point was determined using the parallel plate viscosity method of ASTM C1351M-96(2012).

In embodiments of glasses described herein, the concentration of constituents (e.g., SiO₂, Al₂O₃, B₂O₃, SrO, and the like) are given in mole percent (mol %) on an oxide basis, unless otherwise specified. Constituents of the thermal history-insensitive alkali-free glasses according to embodiments are discussed individually below. Any of the variously recited ranges of one constituent may be individually combined with any of the variously recited ranges for any other constituent.

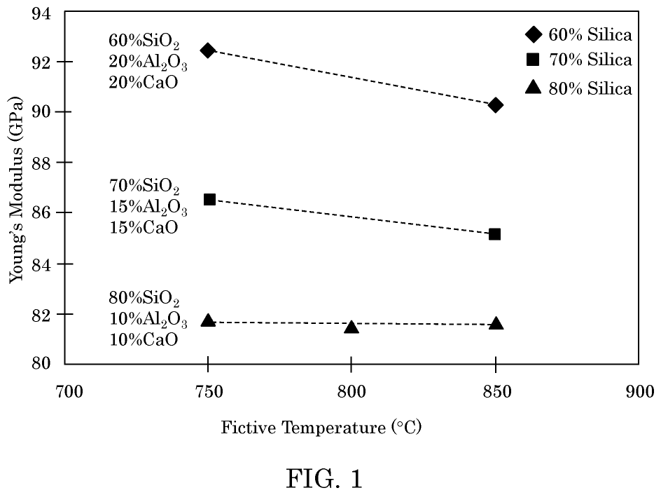

In embodiments of the thermal history-insensitive alkali-free glasses disclosed herein, SiO₂ is the largest constituent and, as such, SiO₂ is the primary constituent of the glass network formed from the glass composition. Moreover, as shown in FIG. 1, the greater the amount of SiO₂, the lower the slope of Young's modulus (dE/dT_{f}) between the anneal point and the strain point can be. FIG. 1 shows data for three glass comprising, top-to-bottom: 60 mol % SiO₂, 20 mol % Al₂O₃, and 20 mol % CaO; 70 mol % SiO₂ 15 mol % Al₂O₃, and 15 mol % CaO; 80 mol % SiO₂, 10 mol % Al₂O₃, and 10 mol % CaO.

Pure SiO₂ has a low CTE and is alkali free. However, pure SiO₂ has a high melting point. Accordingly, if the concentration of SiO₂ in the glass composition is too high, the formability of the glass may be diminished, as higher concentrations of SiO₂ increase the difficulty of melting the glass, which, in turn, adversely impacts the formability of the glass. In embodiments, the glass generally comprises SiO₂ in an amount equal to or greater than about 65.0 mol %, for example, equal to or greater than about 66.0 mol %, equal to or greater than about 67.0 mol %, equal to or greater than about 68.0 mol %, equal to or greater than about 69.0 mol %, equal to or greater than about 70.0 mol %, equal to or greater than about 71.0 mol %, or equal to or greater than about 72.0 mol %, including all ranges and subranges between the foregoing values. In various embodiments, the glass can comprise SiO₂ in amounts from about 65.0 mol % to about 76.0 mol %, for example in a range from about 66.0 mol % to about 75 mol %, in a range from about 67.0 mol % to about 75 mol %, or in a range from about 68 mol % to about 74 mol %, including all ranges and sub-ranges between the foregoing values.

The alkali-free glass may further comprise Al₂O₃. Like SiO₂, Al₂O₃ may serve as a glass network former. Al₂O₃ can increase the viscosity of the glass due to its tetrahedral coordination in a glass melt formed from a glass composition, thereby decreasing the formability of the glass composition if the amount of Al₂O₃ is too high. However, when the concentration of Al₂O₃ is balanced against the concentration of SiO₂ in the glass composition, Al₂O₃ can reduce the liquidus temperature of the glass melt, thereby enhancing the liquidus viscosity and improving the compatibility of the glass composition with certain forming processes, such as the fusion forming process. In embodiments, the glass can comprise Al₂O₃ in an amount equal to or greater than about 14.0 mol %, such as equal to or greater than about 15.0 mol %, for example in a range from about 14 mol % to about 18 mol %, such as in a range from about 15 mol % to about 17 mol %, including all ranges and sub-ranges between the foregoing values.

The sum of the divalent oxides (e.g., MgO, CaO, SrO, and/or BaO, comprising the alkali earth metals) in the glass may be referred to as “RO” and expressed in mol %. Additionally, among the members of RO, those with the lowest field strengths, e.g., CaO, SrO, and BaO, were found to provide lower Young's modulus slopes, dE/dT_{f}, than RO members with greater field strengths, e.g., MgO. As used herein, field strength (F) is defined as charge (Z) divided by the quantity radius of the divalent oxide cation (Rc)+radius of the oxygen anion (Ro), squared:

F=Z/(Rc+Ro)²

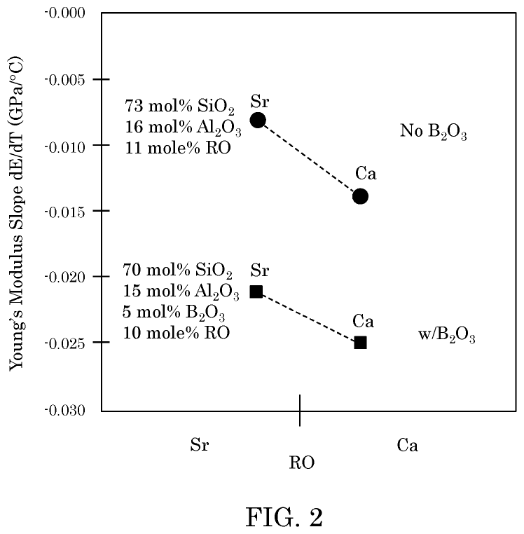

For RO cations, Z is fixed at +2 and Rc increases, and field strength decreases, for example, as one moves down column II of the periodic table from Mg to Ca to Sr to Ba. FIG. 2 visually depicts this effect and illustrates the change in Young's modulus between an alkali-free glass comprising Sr as the alkali earth constituent and an alkali-free glass comprising Ca as the alkali earth constituent for both no B₂O₃ and with B₂O₃. The data show that as the radius Rc increases, and field strength decreases, in going from Ca to Sr, the absolute value of the slope dE/dT_{f} decreases for both a glass without B₂O₃ and a glass with B₂O₃. However, the data also show that the presence of B₂O₃ can be detrimental to the slope, and therefore should be minimized, although some amount of B₂O₃ may be needed to manage viscosity to make melting and refining of the glass less costly. Accordingly, B₂O₃ should be maintained equal to or less than about 5 mol %.

Of the four RO constituents Mg, Ca, Sr and Ba, Ba exhibits the largest radius Rc and the lowest field strength. In some embodiments, the glass may comprise at least one of CaO, SrO, BaO, or a combination thereof. In embodiments, RO can be equal to or less than about 10 mol %. For example, in one or more embodiments, the glass can comprise RO in an amount equal to or less than about 14.0 mol %, such as equal to or less than about 13.0 mol %, equal to or less than about 12.0 mol %, equal to or less than |1 mol %. In various embodiments, RO can be in a range from about 9 mol % to about 12 mol %, for example in a range from about 10 mol % to about 11 mol %, including and ranges and subranges between the foregoing values.

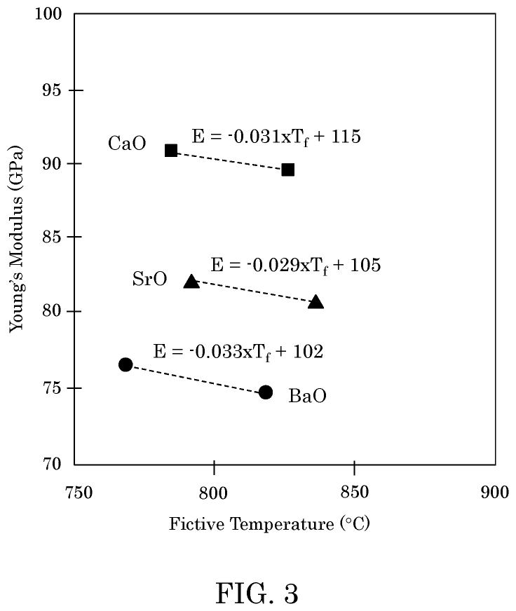

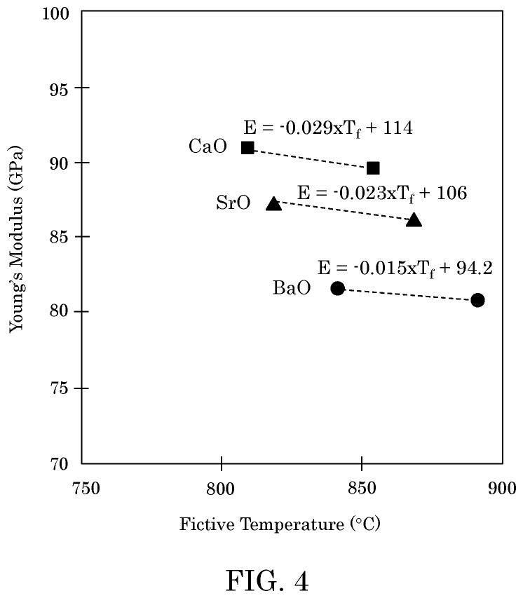

It was further found that when the amount of Al₂O₃ exceeds the amount of RO a reduction in dE/dT_{f} can be obtained. FIG. 3 is a plot showing Young's modulus as a function of fictive temperature between anneal and strain points for three different glasses, each glass comprising a different RO selected from CaO, SrO, and BaO, wherein the amount of Al₂O₃ is less than the amount of RO. More specifically, the glass of FIG. 3 comprised 65 mol % SiO₂, 15 mol % Al₂O₃, and 20 mol % RO. A slope line is illustrated and the slope of the line provided. In the case of RO=CaO, dE/dT_{f} is |0.031| GPa/° C., in the case of RO=SrO, dE/dT_{f} is |0.029| GPa/° C., and in the case of RO=BaO, dE/dT_{f} is |0.033| GPa/° C. In accordance with FIG. 3, RO exceeded Al₂O₃ in each case, with a maximum slope, for RO=BaO, of 10.0331, and indeed, the lowest slope was 10.0291. In comparison, FIG. 4 is a plot showing dE/dT_{f} between anneal and strain points for three similar glasses, each glass comprising a different RO, CaO, SrO, and BaO, wherein the amount of Al₂O₃ is greater than the amount of RO. More specifically, the glass comprised 65 mol % SiO₂, 20 mol % Al₂O₃, and 15 mol % RO. A slope line is illustrated and the slope of the line indicated. In the case of RO=CaO, dE/dT_{f} is |0.029| GPa/° C., in the case of RO=SrO, dE/dT_{f} is |0.023| GPa/° C., and in the case of RO=BaO, dE/dT_{f} is |0.015| GPa/° C. In all three cases (CaO vs. SrO vs BaO), glasses with an amount of Al₂O₃ greater than the amount of RO resulted in reduced slopes of Young's modulus compared to the glasses of FIG. 3, with the smallest slope being |0.015| for the glass comprising BaO. In various embodiments, the ratio of RO/Al₂O₃(RO and Al₂O₃ in mol %) can be in a range from about 0.50 to about 0.7, for example in a range from about 0.6 to about 0.70, including all ranges and subranges between the foregoing values.

In various embodiments, RO+B₂O₃ (RO and B₂O₃ in mol %) can be equal to or less than about 15 mol %, for example in a range from about 9 mol % to about 15 mol %, in a range from about 10 mol % to about 15 mol %, in a range from about 10 mol % to about 14 mol %, or in a range from about 10 mol % to about 13 mol %, such as in a range from about 10 mol % to about 12 mol %, and including all ranges and subranges between the foregoing values.

In embodiments, the alkali-free glass may optionally include one or more fining agents. In some embodiments, the fining agents may include, for example, SnO₂. In such embodiments, SnO₂ may be present in the glass composition in an amount equal to or less than 0.2 mol %, such as from equal to or greater than 0.0 mol % to equal to or less than 0.1 mol %, and all ranges and sub-ranges between the foregoing values. In other embodiments, SnO₂ may be present in the alkali-free glass in an amount from equal to or greater than 0.0 mol % to about 0.2 mol %, or in a range from about 0.1 mol % to about 0.2 mol %, including all ranges and sub-ranges between the foregoing values. However, in other embodiments, the glass may be completely free of SnO₂.

In embodiments, the glass may be substantially free of one or both of arsenic and/or antimony. In other embodiments, the glass may be completely free of one or both of arsenic and/or antimony. Arsenic and antimony are efficient fining agents and have historically been used to refine glass melts by assisting in the removal of gas bubbles in the glass. However, both arsenic and antimony are toxic, and the elimination of arsenic and antimony from various glasses can be environmentally beneficial. By arsenic and/or antimony free what is meant is that the amount of arsenic and/or antimony is equal to or less than about 0.05 mol %.

From the above, alkali-free glasses according to embodiments disclosed herein may be formed by any suitable method, such as slot forming, float forming, rolling processes, fusion forming processes, etc.

The glass article may be characterized by the way it is formed. For instance, where the glass article may be characterized as float-formable (i.e., formed by a float process), down-drawable, and fusion-formable or slot-drawable (i.e., formed by a down-draw process such as a fusion draw process or a slot draw process).

Some embodiments of glass articles described herein may be formed by a down-draw process. Down-draw processes can produce sheet glass articles having a uniform thickness that possess pristine surfaces relative to other processes that contact surfaces of the glass article during forming. Because the average flexural strength of the glass article is controlled by the amount and size of surface flaws, a pristine surface having had minimal physical contact with a forming apparatus has a higher initial strength. In addition, down-drawn glass articles can have a very flat, smooth surface that can be used in its final application without costly grinding and polishing.

Some embodiments of glass articles may be described as fusion-formable (i.e., formable using a fusion draw process). The fusion process uses a forming body comprising a channel for accepting molten material. The channel has weirs at the top along the length of the channel on both sides of the channel. When the channel fills with molten material, the molten material overflows the weirs. Due to gravity, the molten material flows down the outside surfaces of the forming body as two flowing streams of molten material. These outside surfaces of the forming body extend down and inwardly, converging so that they join at a bottom edge of the forming body. The two flowing streams join at this bottom edge and fuse to form a single flowing ribbon which, when sufficiently cooled, can be cut into individual glass sheets if desired, or rolled onto spools. The fusion draw method offers the advantage that, because the two molten streams flowing over the forming body fuse together, neither of the outside surfaces of the resulting glass article contacts any part of the apparatus. Thus, the surface properties of the fusion-drawn glass article are not affected by contact.

Some embodiments of glass articles described herein may be formed by a slot draw process. The slot draw process is distinct from the fusion draw method. In slot draw processes, the molten raw material is provided to a drawing tank. The bottom of the drawing tank comprises an open slot with a nozzle that extends the length of the slot. The molten material flows through the nozzle and is drawn downward from the slot as a continuous ribbon and into an annealing region. In a slot draw process, outside surfaces of the ribbon are contacted by the surfaces of the nozzle.

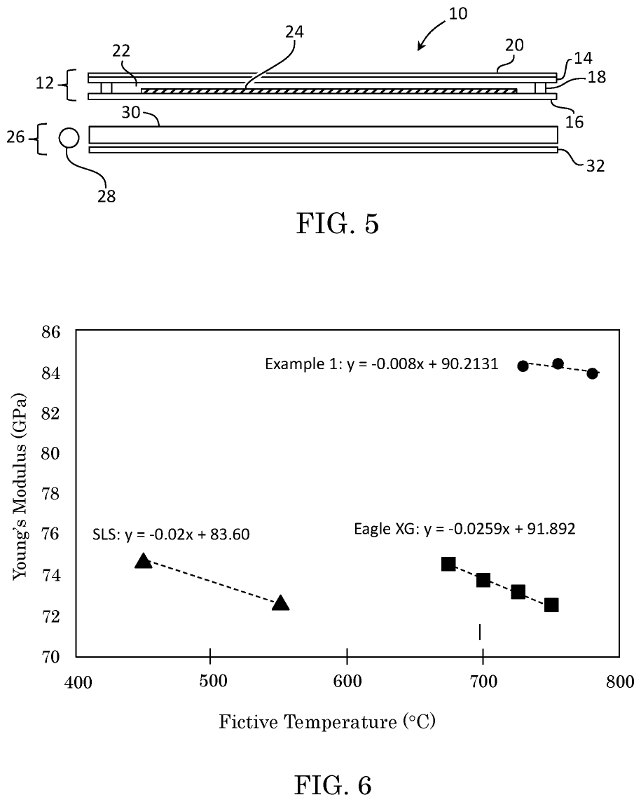

Glass articles disclosed herein may be incorporated into another article such as an article with a display (or display articles) (e.g., consumer electronics, including mobile phones, tablets, computers, navigation systems, and the like), architectural articles, transportation articles (e.g., automobiles, trains, aircraft, sea craft, etc.), appliance articles. For example, FIG. 5 is a cross-sectional drawing of an exemplary display device 10, in this instance an LCD display device, comprising a display panel 12 comprising a first glass substrate 14 and an opposing second glass substrate 16 spaced apart from first glass substrate 14. First and second glass substrates 14 and 16 may be sealed by a sealing material 18 around a peripheral portion of each substrate. Display panel 12 may further comprises one or more films 20 positioned on first glass substrate 14, such as a polarizing film. A liquid crystal material may fill gap 22 between first and second glass substrates 14 and 16. In addition, an electrically functional material may be deposited on second glass substrate 16 within gap 20. Such electrically functional material 24 can be, for example, thin film transistors configured to control a polarization state of the liquid crystal material.

Display device 10 may further comprise a backlight unit 26 positioned behind display panel 12 (relative to an observer), wherein light from light source 28 is injected into an edge surface of light guide plate 30 and extracted from a major surface of light guide plate 26 in a direction toward display panel 12. A reflector 32 may be positioned behind light guide plate 30 to reflect light that may escape through a backside major surface of light guide plate 30 back in a direction toward light guide plate 30. Glasses disclosed herein may be used to form, for example either one or both of first or second glass substrates 14 or 16.

In other embodiments, display devices may comprise electroluminescent elements, wherein the light emitting elements, such as light emitting diodes, for example organic light emitting diodes, are deposed on a substrate, for example a glass substrate comprising a glass disclosed herein, the substrate forming at least a portion of the display panel.

In still other embodiments, glasses disclosed herein can be used in the manufacture of photovoltaic devices, wherein the electrically functional material can be semiconducting materials that exhibit the photovoltaic effect, such as copper indium gallium diselenide, cadmium telluride.

### Examples

Embodiments of thermal history-insensitive alkali-free glasses will be further clarified by the following examples. These examples are not limiting to the embodiments described above.

Alkali-free glasses comprising constituents listed in Tables 1A and 1B below were prepared by conventional glass forming methods. In Tables 1A and 1B, all components are in mol %, and various properties of the glasses were measured according to the methods disclosed herein. Each of the samples in Tables 1A and 1B yielded a glass where the slope of a line extending from the first endpoint to the second endpoint—as defined above and listed in Tables 1A and 1B as “Slope dE/dT (GPa/° C.),” is less than or equal to |0.022|.

TABLE 1A

| | 1 | 2 | 3 | 4 | 5 | 7 | 8 |
|---|---|---|---|---|---|---|---|
| Mol % | | | | | | | |
| SiO₂ | 73.3 | 69.5 | 73.9 | 73.1 | 70.4 | 69.6 | 73.3 |
| Al₂O₃ | 16.3 | 15.4 | 15.8 | 15.9 | 15.2 | 15.4 | 16.0 |
| B₂O₃ | | 4.9 | | | 4.9 | 4.9 | |
| MgO | | 5.0 | 10.1 | 0.2 | | 0.1 | 0.1 |
| CaO | 0.1 | 5.1 | 0.1 | 10.6 | 0.1 | 5.2 | 5.4 |
| SrO | 10.1 | | | | 9.3 | 4.8 | 4.9 |
| BaO | | | | | | | |
| Na₂O | 0.05 | 0.04 | 0.04 | 0.05 | 0.03 | 0.03 | 0.05 |
| SnO₂ | 0.1 | 0.1 | 0.1 | 0.1 | | | 0.1 |
| RO | 10.2 | 10.1 | 10.2 | 10.8 | 9.4 | 10.1 | 10.4 |
| RO/Al₂O₃ | 0.63 | 0.66 | 0.65 | 0.68 | 0.62 | 0.66 | 0.65 |
| RO + B₂O₃ | 10.2 | 15.0 | 10.2 | 10.8 | 14.3 | 15.0 | 10.4 |
| Properties of the | | | | | | | |
| As-Poured Glass | | | | | | | |
| Density (g/cm³) | 2.608 | 2.421 | 2.442 | 2.469 | 2.557 | 2.497 | 2.539 |
| Poisson's Ratio | 0.217 | 0.225 | 0.218 | 0.228 | | | |
| BBV Strain Point (° C.) | 729 | 819 | 718 | 747 | 739 | 738 | 812 |
| BBV Anneal Point (° C.) | 780 | 872 | 765 | 797 | 793 | 792 | 865 |
| PPV Softening Point (° C.) | 1130 | 1015 | 1074 | 1097 | 1046 | 1039 | 1105 |
| Properties as a function | | | | | | | |
| of fictive temperature | | | | | | | |
| Time (hr) | 307 | 440 | 307 | 436 | 239 | 135 | |
| Temperature (° C.) | 729 | 819 | 718 | 747 | 739 | 738 | 812 |
| n measurements | 1 | 17 | 15 | 1 | 15 | 1 | 15 |
| Poisson's Ratio | 0.226 | 0.223 | 0.220 | 0.223 | 0.233 | 0.225 | 0.217 |
| E (Young's Modulus, GPa) | 84.3 | 82.0 | 91.9 | 86.9 | 74.7 | 74.7 | 85.2 |
| G (Shear Modulus, GPa) | 34.3 | 33.5 | 37.7 | 35.5 | 30.3 | 30.3 | 35.0 |
| Time (hr) | 46 | 24 | 45 | 24 | 47 | 24 | |
| Temperature (° C.) | 780 | 872 | 765 | 797 | 793 | 792 | 865 |
| n measurements | 1 | 17 | 9 | 1 | 15 | 1 | 10 |
| Poisson's Ratio | 0.219 | 0.223 | 0.218 | 0.219 | 0.233 | 0.226 | 0.222 |
| E (Young's Modulus, GPa) | 83.8 | 81.5 | 91.4 | 86.2 | 73.5 | 73.5 | 84.6 |
| G (Shear Modulus, GPa) | 34.4 | 33.3 | 37.5 | 35.4 | 29.8 | 29.8 | 34.6 |
| Young's modulus slope as | | | | | | | |
| a function of fictive | | | | | | | |
| temperature at strain and | | | | | | | |
| anneal points | | | | | | | |
| Slope dE/dT_{f} (GPa/° C.) | −0.008 | −0.010 | −0.011 | −0.014 | −0.021 | −0.022 | −0.012 |

TABLE 1B

| | 9 | 10 | 11 | 12 | 13 |
|---|---|---|---|---|---|
| Mol % | | | | | |
| SiO₂ | 70.7 | 71.8 | 73.4 | 75.3 | 72.9 |
| Al₂O₃ | 17.4 | 16.9 | 15.9 | 14.9 | 16.1 |
| B₂O₃ | | | | | |
| MgO | | | 5.1 | | |
| CaO | 0.1 | 0.1 | 5.3 | | |
| SrO | 0.2 | 5.4 | | | |
| BaO | 11.2 | 5.6 | | 9.4 | 10.6 |
| Na₂O | 0.20 | 0.12 | 0.03 | 0.14 | 0.12 |
| SnO₂ | 0.1 | 0.1 | 0.1 | 0.2 | 0.2 |
| RO | 11.5 | 11.1 | 10.4 | 9.4 | 10.6 |
| RO/Al₂O₃ | 0.66 | 0.66 | 0.65 | 0.63 | 0.66 |
| RO + B₂O₃ | 11.5 | 11.1 | 10.4 | 9.4 | 10.6 |
| Properties of the | | | | | |
| As-Poured Glass | | | | | |
| Density (g/cm³) | 2.785 | 2.686 | 2.462 | 2.698 | 2.755 |
| BBV Strain Point (° C.) | 834 | 820 | 792 | 836 | 837 |
| BBV Anneal Point (° C.) | 891 | 874 | 841 | 896 | 894 |
| PPV Softening Point (° C.) | 1136 | 1128 | 1070 | | 1151 |
| Properties as a function | | | | | |
| of fictive temperature | | | | | |
| Time (hr) | | | | | |
| Temperature (° C.) | 834 | 820 | 792 | 836 | 837 |
| n measurements | 15 | 10 | 10 | 20 | 13 |
| Poisson's Ratio | 0.222 | 0.222 | 0.217 | 0.215 | 0.220 |
| E (Young's Modulus, GPa) | 80.3 | 76.6 | 89.2 | 79.4 | 80.1 |
| G (Shear Modulus, GPa) | 32.9 | 31.3 | 36.6 | 32.7 | 32.8 |
| Time (hr) | | | | | |
| Temperature (° C.) | 891 | 874 | 841 | 896 | 894 |
| n measurements | 10 | 10 | 10 | 15 | 15 |
| Poisson's Ratio | 0.220 | 0.220 | 0.226 | 0.215 | 0.223 |
| E (Young's Modulus, GPa) | 79.4 | 75.6 | 88.8 | 78.6 | 79.4 |
| G (Shear Modulus, GPa) | 32.5 | 31.0 | 36.2 | 32.4 | 32.4 |
| Young's Modulus slope | | | | | |
| as a function of fictive | | | | | |
| temperature at strain | | | | | |
| and anneal points | | | | | |
| Slope dE/dT_{f} (GPa/° C.) | −0.017 | −0.017 | −0.008 | −0.013 | −0.012 |

Glass compositions having components listed in Tables 2A and 2B below were prepared by conventional glass forming methods. In Tables 2A and 2B, all components are in mol %, and various properties of the glass compositions were measured according to the methods disclosed in this specification. The viscosity of the glass at the liquidus temperature is measured in accordance with ASTM C965-96(2012), titled “Standard Practice for Measuring Viscosity of Glass Above the Softening Point”. Each of the samples in Tables 2A and 2B are comparative examples that yielded a glass with the slope of a line extending from the first endpoint to the second endpoint—as defined above and listed in Table 2A and 2B as “Slope dE/dT_{f} (GPa/° C.)—is greater than |0.022| GPa/° C.

TABLE 2A

| | 14 | 15 | 16 | 17 | 18 | 19 | 20 | 21 | 22 |
|---|---|---|---|---|---|---|---|---|---|
| Mol % | | | | | | | | | |
| SiO₂ | 69.5 | 66.1 | 65.0 | 65.1 | 61.2 | 59.0 | 59.3 | 68.1 | 50.2 |
| Al₂O₃ | 15.3 | 15.1 | 20.3 | 15.0 | 12.8 | 9.9 | 9.4 | 9.4 | 15.0 |
| B₂O₃ | 4.7 | 9.3 | | 9.5 | 13.6 | 18.3 | 13.4 | 4.5 | 19.2 |
| MgO | 0.2 | | | 0.2 | 0.4 | 0.4 | 0.5 | 0.5 | 0.3 |
| CaO | 10.2 | 0.1 | 0.1 | 10.1 | 11.9 | 12.3 | 17.3 | 17.4 | 15.3 |
| SrO | | 9.4 | 14.3 | | | | | | |
| BaO | | | 0.1 | | | | | | |
| Na₂O | 0.03 | 0.03 | 0.04 | 0.03 | 0.07 | 0.05 | 0.06 | 0.05 | 0.06 |
| SnO₂ | | | 0.1 | | | | | | |
| RO | 10.4 | 9.5 | 14.5 | 10.3 | 12.3 | 12.7 | 17.8 | 17.9 | 15.6 |
| RO/Al₂O₃ | 0.68 | 0.63 | 0.71 | 0.69 | 0.96 | 1.28 | 1.9 | 1.9 | 1.04 |
| RO + B₂O₃ | 15.1 | 18.8 | 14.5 | 19.8 | 25.9 | 31 | 31.2 | 22.4 | 34.8 |
| Properties of the | | | | | | | | | |
| As-Poured Glass | | | | | | | | | |
| Density (g/cm³) | 2.435 | 2.537 | 2.769 | 2.412 | 2.444 | 2.379 | 2.450 | 2.497 | 2.434 |
| BBV Strain | 742 | 685.5 | 819 | 699 | 681 | 637 | 662 | 734 | 637 |
| BBV Anneal | 795 | 740 | 869 | 751 | 729 | 683 | 708 | 783 | 682 |
| PPV Softening | 1027 | 990 | 1087 | 982 | | | | | |
| Properties as a function | | | | | | | | | |
| of fictive temperature | | | | | | | | | |
| Time (hr) | 166 | | | 164 | 430 | 648 | 307 | 190 | 410 |
| Temp. (° C.) | 742 | 686 | 819 | 699 | 681 | 623 | 660 | 741 | 637 |
| n measurements | 1 | 10 | 15 | | | | | | |
| Poisson's Ratio | 0.225 | 0.236 | 0.239 | 0.234 | 0.243 | 0.241 | 0.256 | 0.241 | 0.254 |
| E (Young's Modulus, GPa) | 81.8 | 74.6 | 87.3 | 77.4 | 80.7 | 71.7 | 76.9 | 82.5 | 73.6 |
| G (Shear Modulus, GPa) | 33.4 | 30.2 | 35.2 | 31.4 | 32.5 | 28.9 | 30.6 | 33.2 | 29.4 |
| Time (hr) | 25 | | | 25 | >1 | >1 | >1 | >1 | >1 |
| Temp. (° C.) | 795 | 740 | 869 | 751 | 729 | 683 | 708 | 783 | 683 |
| n measurements | 10 | 14 | 15 | | | | | | |
| Poisson's Ratio | 0.230 | 0.235 | 0.240 | 0.236 | 0.250 | 0.247 | 0.260 | 0.232 | 0.249 |
| E (Young's Modulus, GPa) | 80.4 | 73.2 | 86.1 | 76.0 | 79.3 | 69.6 | 75.1 | 80.9 | 71.6 |
| G (Shear Modulus, GPa) | 32.7 | 29.6 | 34.8 | 30.7 | 31.7 | 27.9 | 29.8 | 32.8 | 28.7 |
| Young's Modulus slope as | | | | | | | | | |
| a function of fictive | | | | | | | | | |
| temperature at strain and | | | | | | | | | |
| anneal points | | | | | | | | | |
| dE/dT_{f} (GPa/° C.) | −0.025 | −0.025 | −0.023 | −0.012 | −0.016 | −0.016 | −0.017 | −0.010 | −0.010 |

TABLE 2B

| | 23 | 24 | 25 | 26 | 27 |
|---|---|---|---|---|---|
| Mol % | | | | | |
| SiO₂ | 63.3 | 59.7 | 45.7 | 59.0 | 66.2 |
| Al₂O₃ | 9.5 | 12.9 | 15.0 | 6.0 | 15.1 |
| B₂O₃ | 9.0 | 8.9 | 23.5 | 12.4 | |
| MgO | 0.5 | 0.5 | 0.3 | 0.6 | |
| CaO | 17.6 | 17.8 | 15.4 | 21.8 | 0.1 |
| SrO | | | | | 18.3 |
| BaO | | | | | 0.1 |
| Na₂O | 0.05 | 0.07 | 0.06 | 0.04 | 0.03 |
| SnO₂ | | | | | 0.1 |
| RO | 18.1 | 18.3 | 15.7 | 22.4 | 18.5 |
| RO/Al₂O₃ | 1.90 | 1.41 | 1.04 | 3.72 | 1.23 |
| RO + B₂O₃ | 27.1 | 27.2 | 39.2 | 34.8 | 18.5 |
| Properties of the | | | | | |
| As-Poured Glass | | | | | |
| Density (g/cm³) | 2.475 | 2.523 | 2.419 | 2.508 | 2.845 |
| BBV Strain Point (° C.) | 683 | 706 | 614 | 633 | 791 |
| BBV Anneal Point (° C.) | 732 | 753 | 658 | 673 | 837 |
| PPV Softening Point (° C.) | | | | | |
| Properties as a function | | | | | |
| of fictive temperature | | | | | |
| Time (hr) | 216 | 819 | 312 | 336 | |
| Temp. (° C.) | 690 | 706 | 614 | 644 | 791 |
| n measurements | | | | | 15 |
| Poisson's Ratio | 0.256 | 0.25 | 0.265 | 0.246 | 0.234 |
| E (Young's Modulus, GPa) | 79.8 | 84.6 | 72.5 | 81.2 | 82.1 |
| G (Shear Modulus, GPa) | 31.8 | 33.9 | 28.6 | 32.6 | 33.3 |
| Time (hr) | >1 | >1 | >1 | >1 | |
| Temp. (° C.) | 732 | 753 | 662 | 673 | 837 |
| n measurements | | | | | 10 |
| Poisson's Ratio | 0.247 | 0.251 | 0.257 | 0.249 | 0.232 |
| E (Young's Modulus, GPa) | 77.8 | 82.0 | 69.9 | 79.4 | 80.8 |
| G (Shear Modulus, GPa) | 31.2 | 32.8 | 27.8 | 31.8 | 32.8 |
| Young's Modulus slope | | | | | |
| as a function of fictive | | | | | |
| temperature at strain | | | | | |
| and anneal points | | | | | |
| dE/dT_{f} (GPa/° C.) | −0.048 | −0.056 | −0.053 | −0.064 | −0.029 |

Tables 1A,B and Tables 2A,B show analyzed compositions and properties of as-poured glasses as well as heat treated glasses as a function of the fictive temperature at the anneal and strain points. The anneal and strain points were measured via the beam bending viscosity method of ASTM C598-93(2013). Fictive temperature was fixed by heat treating the glasses after the initial pour and anneal at the temperatures of the anneal and strain points. Heat treatment was conducted for considerably longer than the necessary times for structural relaxation of the glass to occur. The minimum heat treatment time was 30*viscosity of glass at heat treatment temperature/shear modulus.

Table 3 shows percent improvement in Young's modulus vs. fictive temperature slopes for RO—Al₂O₃—SiO₂ and B₂O₃—RO—Al₂O₃—SiO₂ glasses, demonstrating that glasses with larger ionic radii network modifiers (e.g., Sr instead of Ca) can exhibit lower Young's modulus slopes vs. fictive temperature.

TABLE 3

| Example # | 1 | 4 | 5 | 8 |
|---|---|---|---|---|
| Divalent oxide | 10 SrO | 10 CaO | 9 SrO + | 10 CaO + |
| (batched mol %) | | | 5 B₂O₃ | 5 B₂O₃ |
| Young's | −0.008 | −0.014 | −0.021 | −0.025 |
| Modulus Slope | | | | |
| (GPa/° C.) | | | | |
| % improvement | 42 | | 16 | |
| from Ca to Sr | | | | |

As shown in Table 3, using mixed alkali metal oxides in glass compositions can drive the slope of dE/dT_{f} closer to 0.000, and including larger alkali metal oxides in the glass, such as Sr or Ba compared to CaO can also drive the slope dE/dT_{f} closer to 0.000. Indeed, the glass of Example 8, which is a comparative glass, exceeded 10.022| GPa/° C. for slope dE/dT_{f} whereas the glass of Example 1 has a slope of 10.008| GPa/° C.

Table 4 shows percent improvement in Young's modulus slope vs. fictive temperature for mixed alkali R₂O—Al₂O₃—SiO₂ glass Example 1 vs. soda-lime (SLS) and Corning Eagle XG® (EXG) glass. EXG contains ˜10 mol % RO (8.7 mol % CaO, 2.2 mol % MgO, and 0.51 mol % SrO) and is an alkali-free glass. The data of Table 4 is illustrated graphically in the plot of FIG. 6 depicting Young's modulus as a function of fictive temperature for the three glasses. In FIG. 6, both Example 1 and Eagle XG include additional data point from the anneal and strain points to further increase confidence in the slope of Young's modulus. As described in Table 4, the data show that the slope of Young's modulus between the anneal and strain points for an alkali-free glass in accordance with the present disclosure can be significantly less than other, commercially-available glasses, both containing alkali (e.g., Na for SLS) and alkali-free (Eagle XG).

TABLE 4

| | Alkali or | Young's | % | % |
|---|---|---|---|---|
| | Alkaline | Modulus | improvement | improvement |
| | Earth content | Slope | of Ex. 1 | of Ex. 1 |
| Composition | (mol %) | (GPa/° C.) | vs. SLS | vs. EXG |
| #1 | 10.1 SrO | −0.008 | 60 | 69 |
| SLS | Na-only | −0.0200 | | |
| EXG | Non-alkali | −0.0259 | | |

All compositional components, relationships, and ratios described in this disclosure are provided in mol % unless otherwise stated. All ranges disclosed in this disclosure include all ranges and subranges encompassed by the broadly disclosed ranges whether or not explicitly stated before or after a range is disclosed.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. An alkali-free glass comprising:
equal to or greater than about 65.0 mol % SiO₂;
less than or equal to about 14.0 mol % RO, where RO comprises at least one of MgO, CaO, SrO, or BaO;
RO/Al₂O₃ is equal to or less than about 0.70;
an absolute value of a slope dE/dT_{f} of a line extending between a first endpoint and a second endpoint is less than or equal to |0.022| GPa/° C., wherein
the first endpoint is a Young's modulus of the alkali-free glass at a fictive temperature of an annealing point temperature of the alkali-free glass and the second endpoint is a Young's modulus of the alkali-free glass at a fictive temperature of a strain point temperature of the alkali-free glass.

2. The alkali-free glass of claim 1, further comprising equal to or less than about 5.0 mol % B₂O₃.

3. The alkali-free glass of claim 2, wherein RO+B₂O₃ is equal to or less than about 15.0 mol %.

4. The alkali-free glass of claim 1, wherein dE/dT_{f} is equal to or less than about |0.017| GPa/° C.

5. The alkali-free glass of claim 1, wherein RO comprises at least one of Sr, Ca or BaO.

6. The alkali-free glass of claim 1, wherein RO is in a range from about 9.0 mol % to about 12.0 mol %.

7. The alkali-free glass of claim 1, wherein SiO₂ is equal to or greater than about 70.0 mol %.

8. An alkali-free glass comprising:
equal to or greater than about 65.0 mol % SiO₂;
equal to or less than about 5.0 mol % B₂O₃;
less than or equal to about 14.0 mol % RO, where RO comprises at least one of MgO, CaO, SrO, or BaO;
RO/Al₂O₃ is equal to or less than about 0.70;
RO+B₂O₃ is equal to or less than about 15 mol %; and
an absolute value of a slope dE/dT_{f} of a line extending between a first endpoint and a second endpoint is less than or equal to |0.022| GPa/° C., wherein the first endpoint is a Young's modulus of the alkali-free glass at a fictive temperature of an annealing point temperature of the alkali-free glass and the second endpoint is a Young's modulus of the alkali-free glass at a fictive temperature of a strain point temperature of the alkali-free glass.

9. The alkali-free glass of claim 8, wherein SiO₂ is equal to or greater than about 70.0 mol %.

10. The alkali-free glass of claim 8, wherein RO comprises at least one of Sr or BaO.

11. The alkali free glass of claim 8, wherein the absolute value of the slope is less than or equal to 10.020| GPa/° C.

12. The alkali-free glass of claim 8, wherein the absolute value of the slope is less than or equal to |0.017| GPa/° C.

13. The alkali-free glass of claim 8, further comprising Al₂O₃ in an amount from about 15.0 mol % to about 18.0 mol %.

14. The alkali-free glass of claim 8, further comprising B₂O₃ in an amount equal to or less than about 5.0 mol %.

15. A glass article, comprising:
a first glass substrate, the first glass substrate comprising an electrically-functional element deposited thereon, the first glass substrate further including an alkali-free glass comprising:
equal to or greater than about 65.0 mol % SiO₂;
less than or equal to about 14.0 mol % RO, where RO comprises at least one of MgO, CaO, SrO, or BaO;
RO/Al₂O₃ is equal to or less than about 0.70;
an absolute value of a slope dE/dT_{f} of a line extending between a first endpoint and a second endpoint is less than or equal to 10.022| GPa/° C., wherein
the first endpoint is a Young's modulus of the alkali-free glass at a fictive temperature of an annealing point temperature of the alkali-free glass and the second endpoint is a Young's modulus of the alkali-free glass at a fictive temperature of a strain point temperature of the alkali-free glass.

16. The glass article of claim 15, wherein the electrically-functional element comprises an electroluminescent element.

17. The glass article of claim 15, wherein the electroluminescent element comprises a light emitting diode.

18. The glass article of claim 15, wherein the electroluminescent element comprises an organic light emitting diode.

19. The glass article of claim 15, wherein the electrically-functional element comprises a photo-electric element.

20. The glass article of claim 15, wherein the alkali-free glass further comprises equal to or less than about 5.0 mol % B₂O₃.

21. The glass article of claim 20, wherein RO+B₂O₃ is equal to or less than about 15 mol %.

22. The glass article of claim 15, wherein RO comprises at least one of Sr, Ca or BaO.

23. The glass article of claim 15, wherein SiO₂ is equal to or greater than about 70.0 mol %.
